(19) United States
(12) Patent Application Publication
(10) Pub. No.: US 2022/0026570 A1
(43) Pub. Date: Jan. 27, 2022

(54) TECHNIQUES FOR SONAR DATA PROCESSING

(71) Applicant: CODA OCTOPUS GROUP INC., Orlando, FL (US)

(72) Inventors: Blair G. Cunningham, Orlando, FL (US); Angus McFadzean, Edinburgh (GB); Charlie Pearson, Bristol (GB); Martyn Sloss, East Wemyss (GB)

(21) Appl. No.: 17/493,638

(22) Filed: Oct. 4, 2021

Related U.S. Application Data
(63) Continuation-in-part of application No. 16/775,060, filed on Jan. 28, 2020.
Application No. 16/775,060 is a continuation-in-part of application No. 16/729,404, filed on Dec. 29, 2019.
Application No. 16/729,404 is a continuation-in-part of application No. 16/727,198, filed on Dec. 26, 2019.
(60) Provisional application No. 62/932,734, filed on Nov. 8, 2019.
(60) Provisional application No. 62/931,956, filed on Nov. 7, 2019.
(60) Provisional application No. 62/932,734, filed on Nov. 8, 2019.
(60) Provisional application No. 62/931,956, filed on Nov. 7, 2019.
(60) Provisional application No. 62/932,734, filed on Nov. 8, 2019.
(60) Provisional application No. 62/931,956, filed on Nov. 7, 2019.

(51) Int. Cl. G01S 15/89; G10K 11/34; G01S 7/53

(52) U.S. Cl. CPC G01S 15/8925; G01S 7/53; G10K 11/34

(57) ABSTRACT

A sonar system comprising a sonar transmitter, a very large array two dimensional sonar receiver, and a beamformer section transmits a series of sonar pings into an insonified volume of fluid at a rate greater than 5 pings per second, receives sonar signals reflected and scattered from objects in the insonified volume, and beamforms the reflected signals to provide a video presentation and/or to store the beamformed data for later use. The parameters controlling the sonar system are changed so that the beamformer section treats the data from the receiver section with more than one set of parameters. The stream of data is treated either in parallel or in series by different beamforming methods so that at least one beam from the beamformer has more than one value.

### CROSS-REFERENCE TO RELATED APPLICATIONS

This application is a Continuation-in-Part application of U.S. patent application Ser. No. 16/775,060, entitled “METHOD OF RECORDING SONAR DATA,” filed Jan. 28, 2020, U.S. patent application Ser. No. 16/729,404, entitled “VIDEO IMAGING USING MULTI-PING SONAR,” filed Dec. 29, 2019, and U.S. patent application Ser. No. 16/727,198, entitled “VIDEO IMAGING USING MULTI-PING SONAR,” filed Dec. 26, 2019, each of which claimed priority to U.S. Provisional Patent Application Ser. No. 62/932,734, filed Nov. 8, 2019 and U.S. Provisional Patent Application Ser. No. 62/931,956, filed Nov. 7, 2019. These applications are each hereby incorporated by reference in their entireties.

### TECHNICAL FIELD

Embodiments presented herein generally relate to sonar imaging, and more specifically, to techniques for visualizing and using data from sonar signals scattered from objects immersed in a fluid.

### SUMMARY

A series of sonar pings are sent into an insonified volume of water and reflected or scattered from submerged object(s) in the insonified volume of water. One or more large sonar receiver arrays of sonar detectors are used to produce and analyze sonar data to produce 3 dimensional sonar data describing the submerged object(s) for each ping. One or more parameters controlling the sonar imaging system are changed between pings and/or within a single ping in the series of pings. The resulting changed data are stored and/or combined together to produce an enhanced video presentation of the submerged objects at an enhanced video frame rate of at least 5 frames per second. More than one of the parameters used to control the sonar imaging system are used to produce different 3D images from the same ping in a time less than the time between two pings.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 shows a sketch of the layout where the method of the invention may be used.

FIGS. 2A, 2B and 2C show side elevation, plan view and end elevation views of the sonar transmitter of the invention.

FIG. 3 shows possible configurations of the sonar transmitter of the invention.

FIGS. 4A and 4B show the sonar transmitter of the invention sending out pings in a 50 degree included angle and a 25 degree included angle.

FIGS. 5A, 5B and 5C show plan view, side elevation, and end elevation views of the sonar receiver of the invention.

FIG. 6 shows a flow chart of the method of the invention.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

It has long been known that data presented in visual form is much better understood by humans than data presented in the form of tables, charts, text, etc. However, even data presented visually as bar graphs, line graphs, maps, or topographic maps requires experience and training to interpret them. Humans can, however, immediately recognize and understand patterns in visual images which would be difficult for even the best and fastest computers to pick out. Much effort has thus been spent in turning data into images.

In particular, images which are generated from data which are not related to light are often difficult to produce and often require skill to interpret. One such type of data is sonar data, wherein a sonar signal pulse is sent out from a sonar generator into a volume of sea water or fresh water of a lake or river, and reflected sound energy from objects in the insonified volume is measured by a sonar receiver.

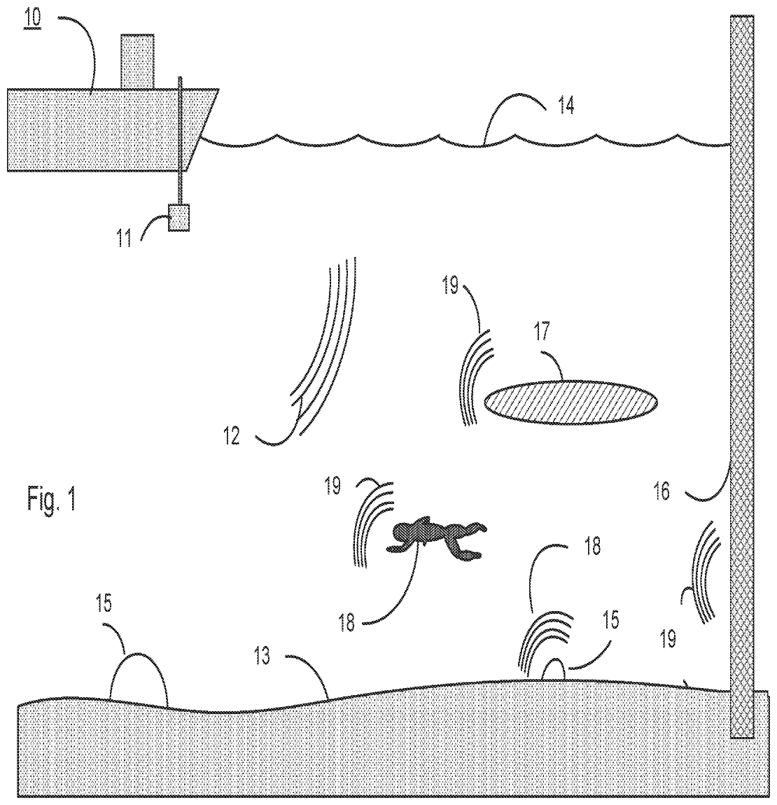

The field of underwater sonar imaging is different from the fields of medical ultrasonic imaging and imaging of underground rock formations because there are far fewer sonar reflecting surfaces in the underwater insonified volume. Persons skilled in the medical and geological arts would not normally follow the art of sonar imaging of such sparse targets. FIG. 1 shows a sketch of the system of the invention. A vessel 10 carrying the apparatus 11 (also referred to herein as a sonar imaging system) of the invention is on the surface 14 of a body of water. The water rests on a seabed 13. It is understood that any fluid that supports sound waves may be investigated by the methods of the present invention. The apparatus 11 generally comprises a sonar ping transmitter (or generator) and a sonar receiver, but the sonar transmitter and receiver may be separated for special operations. Various sections of the apparatus are each controlled by controllers which determine parameters required for optimum operation of the entire system. In the present specification, a parameter is a specific value to be used which can be changed rapidly between pings. The parameters may be grouped in sets and the set can be switched, either by hand or automatically according to a criterion. The decision to switch parameters may be made by an operator or made automatically based on information gained from prior pings sent out by sonar transmitter or by information gained from the current ping. FIG. 1 shows the sonar transmitter sending out pulses of sound waves 12 which propagate into the water in an approximately cone shaped beam. The pulses 12 strike objects in the water such as stones 15 on the seabed 13, an underwater vessel 17, a swimming diver 18, and a sea wall 16. The vessel 17 may either be manned or be a remotely operated vessel (ROV). The objects underwater that have a different density than the sea water reflect pulses 19 as a generally expanding waves back toward the apparatus 11.

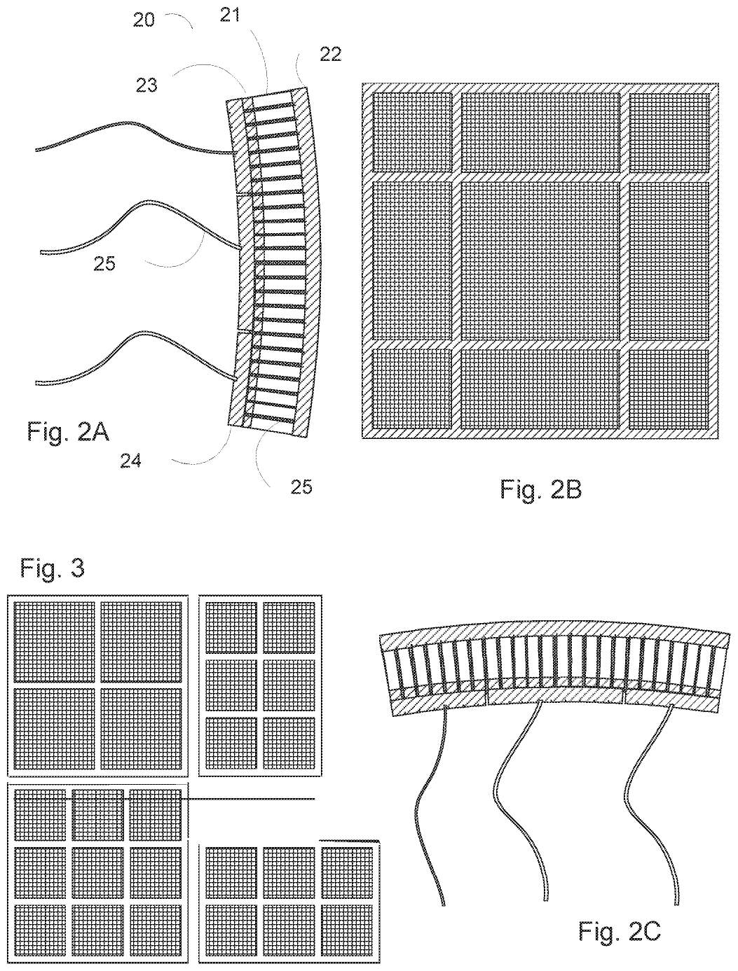

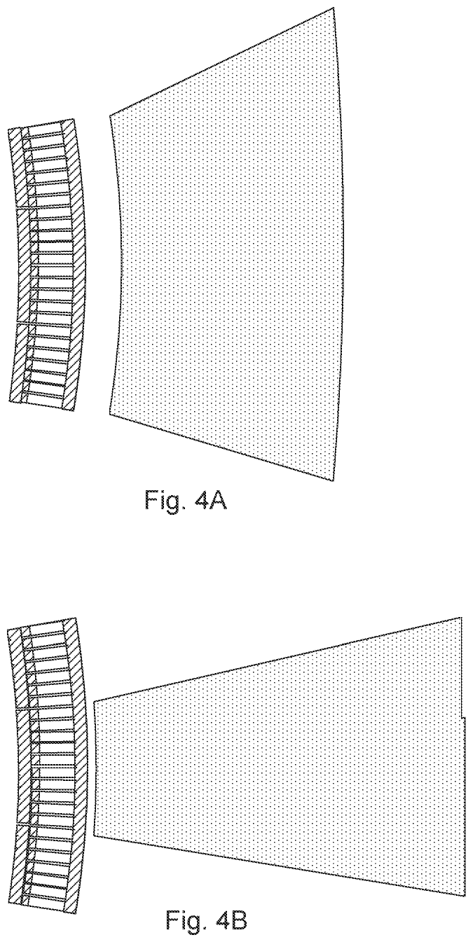

The term “insonified volume” is known to one of skill in the art and is defined herein as being a volume of fluid through which sound waves are directed. In the present invention, the sonar signal pulse of sound waves is called and defined herein as a ping, which is sent out from one or more sonar ping generators or transmitters, each of which insonifies a roughly conical volume of fluid. A sonar ping generator is controlled by a ping generator controller according to set of ping generator parameters. Ping generator parameters comprise ping sonar frequency, ping sonar frequency variation during the ping pulse, ping rate, ping pulse length, ping power, ping energy, ping direction with respect a ping generator axis, and 2 ping angles which determine a field of view of the objects. A ping generator preferably has a fixed surface of material which is part of a sphere, but may shaped differently. Example ping generators of the invention are sketched in FIGS. 2 through 4. FIG. 2A shows a ping generator cross section 20 with piezo electric elements 21 sandwiched between electrically conducting materials 22 and 23. Material 25 between the piezo electric elements is electrically insulating. The electrically conducting material 22 is preferably a solid sheet of material which is grounded and is in contact with the seawater. Material 22 is thin enough that ultrasonic pressure waves can easily pass through it, but thick enough that water does not leak through it and get into the interior of the ping generator. The other end of the piezoelectric material elements 21 is energized by applying an ultrasonic frequency voltage to electrical elements 24 which are separated electrically from each other and which energize groups of piezo electric elements 21 to vibrate with the same phase and frequency. Wires 25 are sketched to show the electrical connections to the different segments 24. The plan view of the transmitter shows the elements 24 in FIG. 2B shown segmented into 9 segments. FIG. 3 shows other example segmentation schemes useful in the method of the invention. FIG. 4A shows the beam pattern of the outgoing sonar waves if all the elements 21 are energized with the same phase and frequency electrical signal. FIG. 4B shows the beam pattern of the outgoing sonar waves if only the elements 21 in the center section of FIG. 2B are energized with the same phase and frequency electrical signal. For the relative size and curvature of the surfaces 25 of FIG. 4A, the full beam has a divergence of 50 degrees and the restricted beam shown in FIG. 4B has a divergence of 25 degrees. By energizing appropriate combinations of electrodes, the beam may be sent out up, down, left, or right.

Ping generators of the prior art could send out a series of pings with a constant ping frequency during the ping. Ping frequencies varying in time during the sent out ping are known in the prior art. Changing the ping frequency pattern, duration, power, directions, and other ping parameters rapidly and/or automatically between pings in a series has not heretofore been proposed. One method of the invention anticipates that the system itself uses the results from a prior ping can be analyzed automatically to determine the system parameters needed for the next ping, and can send the commands to the various system controllers in time to change the parameters for the next ping. When operating in a wide angle mode at a particular angle and range, for example, a new object anywhere in the field of view can signal the system controllers to send the next outgoing ping the direction of the object, decrease the field of view around the new object, increase the number of pings per second according to a criterion based on the distance to the object, set the ping power to optimize conditions for the range of the object, etc. Most preferably, the system can be set to automatically change any or all system parameters to optimize the system for either anticipated or in reaction to unanticipated changes in the environment.

In an embodiment, the controller system may be set to change the sent out frequency alternately between a higher and a lower frequency. The resulting images alternate between a higher resolution and smaller field of view for the higher frequency, and a lower resolution and a larger field of view for the lower frequency. The alternate images may then be stitched after the receiver stage to provide a video stream at half the frame rate of the system available with unchanged parameters, but with higher central resolution and wider field of view, or at the same frame rate by stitching neighboring images.

Intelligent steering of the high-resolution, focused field of view on to a specific target of interest would mean that this technology would not necessarily be limited only to short range applications. If only one of the four steered pings, for example, needs to be continuously updated to generate real-time images, then the range limit could be significantly extended. The intelligent focusing may be implemented in a mode whereby a low-frequency, low-resolution ping with a large field of view is used to locate the target of interest. The subsequent high-frequency, high-resolution ping may then be directed to look specifically at the region of interest without having to physically steer the sonar head.

In such an embodiment, additional intelligent and predictive processing and inter-frame alignment may be used to account for and track motion and moving objects. The priority of frame processing may be adapted to allow focus and higher refresh rate of images including the primary target, for example with the field of view centered on a primary target, or moving objects requiring the images that represent a portion of the field of view containing moving object to be updated more frequently.

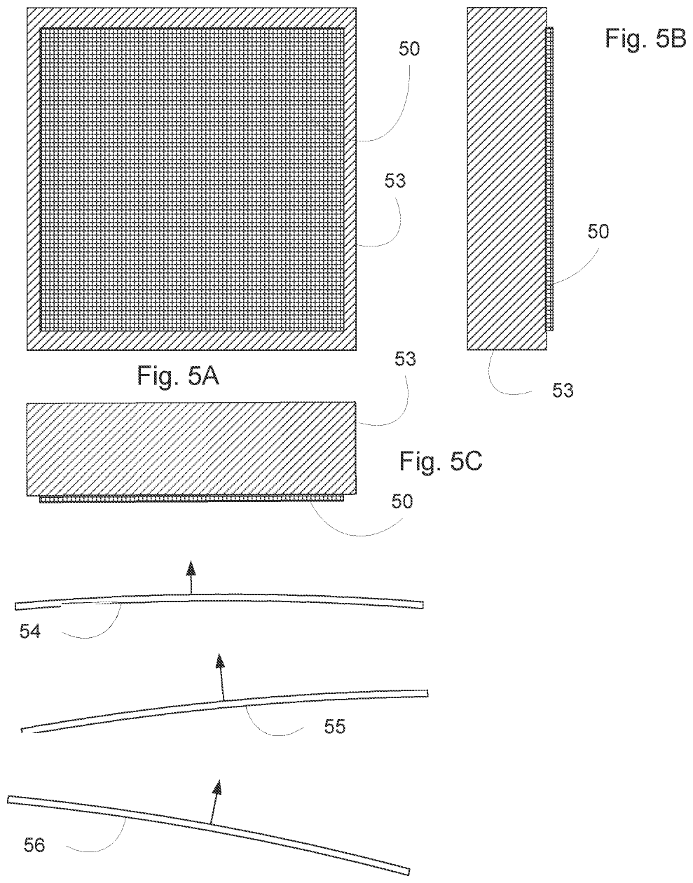

The sonar receiver of the invention is a large array of pressure measuring elements. The sonar receiver is controlled by a sonar receiver controller according to set of sonar receiver parameters. The array is preferably arranged as a planar array shown in FIG. 5 because it is simpler to construct, but may be shaped in any convenient form such as a concave or convex spherical form for different applications. The array has preferably 24 times 24 sonar detecting elements, or more preferably 48 times 48 elements, or even more preferably 64 time 64 detectors, or most preferably 128 times 128 elements. A square array of elements is typically used in practice, but the array may be a rectangular array or a hexagonal array or any other convenient shape. The detector elements are generally constructed by sandwiching a piezo electric material between two electrically conducting materials as shown for the sonar transmitter, but with an electrical connection to each element in the array. When a reflected sonar ping reaches the sonar detecting element, the element is compressed and decompressed at the sonar ping frequency, and produces a nanovolt analog signal between the electrically conducting materials. The nanovolt signals are amplified and digitally sampled at a sonar receiver sampling rate controlled by the sonar receiver controller, and the resulting digital signal is compared to a signal related to sent out ping signals to measure the phase and amplitude of the incoming sonar signals for each receiver element. The amplification or gain for the incoming sonar signals is controlled by the sonar receiver controller. If the sonar ping frequency is changed rapidly between pings, the sampling rate may also be changed to reflect the changed ping frequency. The incoming sonar ping is divided into consecutive slices of time, where the slice time is related to the slice length by the speed of sound in the water. A slice time parameter is set by the sonar receiver controller. For example, pings arriving from more distant objects can have wider slices than pings reflections from closer objects. Each slice contains a number of sonar wavelengths as the pulse travels through the water. The sonar receiver preferably has sonar receiver parameters controlled by the sonar receiver controller to have, for example, programmable phase delays between the detector elements digital sampling times may be varied to achieve the same result. The sonar receiver may have parameters controlled by the sonar receiver controller which can be set to change the amplification or gain of the nanovolt electrical signals during the incoming sonar ping reflected signals. Prior art time varying gain (TVG) systems have used preplanned amplification ramps to correct for attenuation in the water column. This gain is applied based on range (distance from transmitter), but the gain profile does not change from ping to ping. Generally, the attenuation of the ultrasonic waves is higher for higher ping frequencies. Prior art changed the amplification factor by a preplanned schedule to even out the signals between the received first slice and the last slice of a ping. Prior TVG did not allow for the increased absorption by soft mud on the seafloor, for example. Since mud absorbs sound waves, the reflected sound waves are less intense as soon as the reflected slice reaches the mud. The TVG is changed on the next ping to boost the signals that reflect or are scattered by the mud. In the same way, the TVG is changed to boost or reduce the gain for slices that more strongly reflect or are scattered by a hard, highly reflecting object like the sea wall shown in FIG. 1.

A phase and amplitude of the pressure wave coming into the sonar receiver is preferably assigned to each detector element for each incoming slice, and a phase map may be generated for each incoming slice. A phase map is like a topographical map showing lines of equal phase on the surface of the detector array.

FIG. 5C sketches a reflected ping 54 reflected by first object at a range of 20 detector widths from the detector. The first object is on a line starting from the center of the detector and perpendicular to the detector surface. The scattered ping is shown having a spherical surface to reflect a wave with origin at the surface of the first object. The phase map for this ping will be a series of circular regions centered in the center of the detector, all having the same phase, and moving outward from the center of the detector as the various slices of the ping are analyzed. Reflected ping 55 indicates a second object located further away from the detector than the first object, and at an angle of 5 degrees to the right of the center line. Reflected ping 56 shows a third object located yet further away from the detector, and at an angle of 10 degrees to the left of the center line. Pings 55 and 56 produce similar rings originating to the left and right of the detector, and expanding as slightly elliptical rings outwardly from their centers (which are not located on the detector for the angles shown).

Applying additional gain control can be incorporated with Phase Filtering.

Phase map and data cleanup and noise reduction may be done optionally in the sonar receiver or in a beamformer section. The phase map and/or the digital stream of data from the detector are passed to the beamformer section, where the data are analyzed to determine the ranges and characteristics of the objects in the insonified volume.

The range of the object is determined by the speed of sound in the water and the time between the outgoing ping and the reflected ping received at the receiver. The data are most preferably investigated by using a spherical coordinate system with origin in the center of the detector array, a range variable, and two angle variables defined with respect to the normal to the detector array surface. The beamformer section is controlled by a beamformer controller using a set of beamformer parameters. The space that the receiver considers is divided into a series of volume elements radiating from the detector array and called beams. The center of each volume element of a beam has the same two angular coordinate and each volume element may have the same thickness as a slice. The beam volume elements may also preferably have thickness proportional to their range from the detector, or any other characteristic parameters as chosen by a beamformer controller. The range resolution is given by the slice thickness.

The beamformer controller controls the volume of space “seen” by the detector array and used to collect data. For example, if the sonar transmitter sends out a narrow or a broad beam, or changes the direction of the sent out beam, the beamformer may also change the system to only look at the insonified volume. Thus, the system of the invention preferably changes two or more of the system parameters between the same pings to improve the results. Some of the parameters controlled by the beamformer controller are: Field-of-view; Minimum and maximum beamformed ranges; Beam detection mode such as (First Above Threshold FAT or maximum amplitude (MAX) or many other modes as known in the art); Range resolution; Minimum signal level included in image; Image dynamic range; Array weighting function (used to modify the beamforming profile); and, Applying additional gain post beamforming (this can be incorporated with Thresholding).

The incoming digital data stream from each sonar detector of the receiver array has typically been multiplied by a TVG function. A triangular data function ensures that the edges of the slices have little intensity to reduce digital noise in the signal. The TVG signal is set to zero to remove data that is collected from too near to and too far away from the detector, and to increase or decrease the signal depending on the situation.

In the prior art, the data have been filtered according to a criterion, and just one volume element for each beam was selected to have a value. For example, if the data was treated to accept the first signal in a beam arriving at the detector having an amplitude above a defined threshold (FAT), the three dimension point cloud used to generate an image for the ping would be much different from a point cloud generated by picking a value generated by using the maximum signal (MAX). In the FAT case, the image would be, for example, of fish swimming through the insonified volume and the image in the MAX case would be the image of the sea bottom. In the prior art, only one range in each beam would show at most one value or point and all the other ranges of a single beam would be assigned a zero.

In the present invention, the data stream is analyzed by completing two or more beamformer processing procedures in the time between two pings, either in parallel or in series. In a video presentation, the prior art showed a time series of 3D images to introduce another, fourth dimension time into the presentation of data. By introducing values into more than one volume element per ping, a fifth dimension can be introduced to the presentation. The sonar imaging system can “see” behind objects, for example and “through” objects and “around” objects to get much more information. The sonar imaging system can use various data treatments to improve the video image stream. In the same way, other ways of analyzing the data stream can be used to accomplish provide cleaner images, higher resolution images, expanded range images, etc. These different images imaging tasks to can be used on only one ping. The different images may be combined into a single image in a video presentation, or in more than one video at the frame rate the same as the ping rate.

If the sonar imaging system is surveying a seawall, the sonar imaging system beamforms the data before the wall (sea bottom-oblique to beams (low backscatter) soft (low intensity signals returned)) differently from the harbor wall (orthogonal to beams (high back scatter) hard, high intensity. If the sonar imaging system knows where a seawall is from a chart, the beamformer can use GPS or camera data to work out what ranges are before the wall and what are after and change TVG in the middle of the returned ping.

If the sonar imaging system knows the sea depth the sonar imaging system can specify two planes, SeaSurfacePlane and SeatBottomPlane, only data between the planes will be processed and sent from the head to the top end.

A large amount of data generated per second by prior art sonar systems has traditionally been discarded because of data transmission and/or storage limits. The present invention allows a higher percentage of the original data generated to be stored for later analysis. The present invention makes use of a prior invention (U.S. application Ser. No. 15/908,395 filed Feb. 28, 2018) assigned to the assignee of the present invention. In this invention, the raw data is not digitized by using analogue to digital circuitry, but by comparator technology which drastically reduces the equipment cost for the large sonar arrays used. The amount of amount of raw data sent from the receiver to the beamformer is drastically reduced, allowing the beamformer to produce more data than a single beamformer parameter set data per ping.

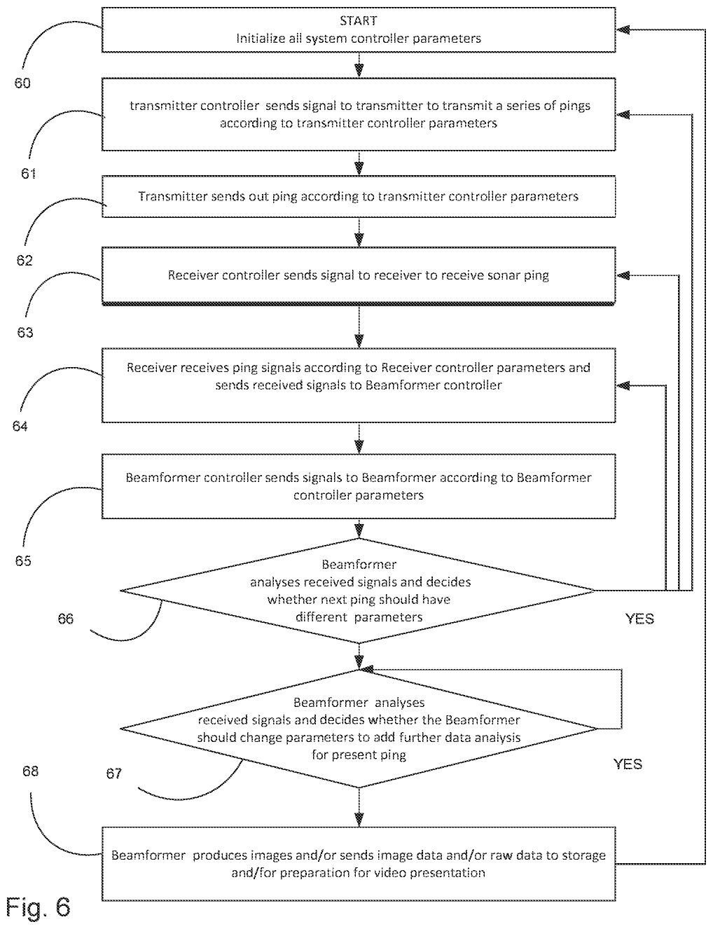

FIG. 6 shows a flowchart of the method of the invention. The start 60 of the process of sending out a ping is to set all system parameters for all system controllers. Either all parameters are the same as the last ping, or they have been changed automatically by signals from stages of the previous ping. Step 60 sends signal to step 61 to send commands to transmitter 62. Transmitter sends data to receiver controller 63 to set parameters for receiver 64 and start receiver 64. Receiver receives analogue signals, samples the voltages from each element, and transmits data to the beamformer controller which sends data and instructions to the Beamformer section.

The beamformer analyses data and decides whether the next ping should change settings, and if so sends signals to the appropriate controller to change the settings for the next ping. The beamformer analyses the data in step 67 and decides either on the basis of incoming ping data or on previous instructions whether to perform single or multiple types of analysis of the incoming ping data. For example, the beamformer could analyze the data using both the FAT and MAX analysis, and present both images either separately or combined, so that there will be some beams having more than one value per beam. The reduced data is sent from step 67 to step 68 which stores or sends raw data or image data for further processing into a video presentation at a rate greater than 5 frames per second. In addition, a frame rate of 10 frames a second and a frame rate of 20 frames per second may also be applied.

Sonar imaging techniques generally include scanning an object to produce a sequence of images which could be used to produce a 3 dimensional (3D) shape. The limitation of this approach is the inability to see any moving objects and the dependency of a stable platform to record perform the imaging. Sonar imaging systems, such as the systems described herein, allow moving objects in the water column to be viewed in real time. 4D volumetric images represent a true volume of spatial data collected and processed at the same instant. Sequential 4D volumetric images represent a time sequence of the scene showing moving objects within the volumetric image. Sonar imaging systems according to the present disclosure are also capable of 5D and 6D imagery. 5D images are 4D images with multiple slices of depth data, similar to a medical CT scan. The 5D images contain more depth information, detail, and resolution of each target and sequential 5D images over time show higher resolution moving targets. 6D Parallel Intelligent Processing Engine (PIPE) allows multiple parallel 5D images to be generated with different imaging and sonar parameters. This allows different processing to be performed on raw sonar data in parallel to extract more specific results without compromise.

Legacy sonar imaging systems revolutionized 3D sonar by simultaneously beamforming a grid of over 16,000 beams, allowing a full 3D depth image to be generated in under 1/10th of a second. This rapid processing allows the system to deliver real-time 3D output and generate video-quality-like 3D views of moving objects in the water column.

In an embodiment, the sonar imaging system of the present disclosure includes a specialized processor that allows the sonar data to be handled orders of magnitude faster, and with much greater flexibility, or stored for off-line processing. The biggest change facilitated by this processor is the ability to beamform the entire duration of each sonar ping to give full time series (FTS) data on all beams. Rather than just returning at most a single 1 dimensional range point for each beam to create an image with a maximum 16,384 points), the system described herein returns a fully populated volume of over 1.6 million beamformed data points, while still operating at over 20 pings per second.

The ability to return multiple data points on every beam takes the data to the next generation and presents a wealth of new opportunities for analyzing the sonar data. The biggest initial advantage is that the 5G system generates much fuller, and more detailed images when the points are rendered in 3D, as the beamformer can potentially see around smaller objects in the near-field. The system also returns multiple range points for beams striking flat surfaces at high incidence angles, meaning that the seafloor is much better resolved in the far field of the volume image.

The specialized processor has also allowed the sensitivity of the beamformer to be increased, as its floating-point operation allows for a much greater dynamic range in the data. This is a significant advantage in many acoustically challenging applications and environments. The combination of having multiple range points recorded for each beam and the increase in sensitivity means that the far-field can be much more clearly and densely resolved in the output images.

The major increase in the quality and volume of data generated by the 5G system means that new types of data processing are possible, and new, useful information can be extracted. The challenge with large datasets, however, is that they can be slow and cumbersome to analyze. In an embodiment, PIPE adopts novel parallel processing methods to perform multiple, simultaneous analyses of the large 5G dataset, delivering a range of useful outputs in real time. This ability to produce multiple, concurrent 5GD datasets takes the new system to its sixth data generation (6G).

The development of PIPE may also implement update to maximize the functionality of this new tool. Different 5G data outputs might require different signals to be transmitted from the sonar, or might need different signal amplification and filtering operations to be applied. For example, one task might need high-resolution and a narrow field of view, while another could require a low-frequency, long range signal with a wide field of view. PIPE allows these different 5G datasets to be processed concurrently by switching between many different sets of sonar operating parameters, with this switching occurring from ping to ping at 20 Hz. It is possible, for example, to generate four completely different 5G sonar images separated by less than 0.05 sec, with the composite, 6G image being fully updated 5 times per second.

To understand the full potential of this new technology, consider a pipe inspection operation being conducted with an ROV. The ROV pilot requires a longer range, forward looking view to allow both navigation and obstacle avoidance. There could then be an engineer inspecting the condition of the pipe itself, who requires a high resolution, downward looking image to be able to detect damage or corrosion on the pipe. The 6G PIPE system is capable of generating both these images simultaneously in real time, meaning that the engineers are able to make instant decisions, such as whether to slow down to inspect a particular section of pipe in more detail.

Since the raw data from the survey is also being stored, it is possible to go back through the data in post-processing and apply different image processing methods to highlight different information. This does not provide quite the same flexibility as the real-time 6G processing, as the transmit and receive parameters are fixed. There is still significant value, however, in having access to the measured raw data rather than a processed image that has already removed a large proportion of the original information.

In addition, the sonar imaging system described herein may be adapted to various settings, such as in a fully autonomous vehicle. As an example, the system could be operated to simultaneously provide a far-field obstacle avoidance view, and a high-resolution seabed view for detailed autonomous navigation. The raw data could then be stored for subsequent human post-processing and analysis once the AUV is returned to the surface.

Obviously, many modifications and variations of the present invention are possible in light of the above teachings. It is therefore to be understood that, within the scope of the appended claims, the invention may be practiced otherwise than as specifically described. For example, one of skill in the art may adapt the above disclosure to various techniques, as further described below.

A Method of Producing a 5D or 6D Sonar Image

Conventional sonar imaging system sonars transmit a ping of acoustic sound and use a 2D array of receiving elements to acquire any returned echoes over a set time period, equating to range. The received element data is processed into a 2D array (two angles with respect to the 2D array of receiving elements) of received beams, where each beam has a known, unique, 2D directionality over a defined area. Each beam's time-series of echo-strength (termed amplitude data) is then processed looking for a single “target” in each beam; typically, the “strongest” target. (Other, weaker signal targets are usually ignored to save processing time and memory Since the angle of each beam is known and the time of echo from each target is measured (which, when combined with the speed of sound in water, allows range to be calculated), the relative 3D (two angles and range) position of each target from the sonar can be calculated. Optionally, combining this data with the sonar's position and orientation, an absolute 3D position for each target can be determined. In this manner a 3D sonar image can be generated where the image covers an overall viewing volume.

When the above processing techniques are done in real-time and multiple pings are processed in time sequence, 4D (3 position coordinates and time) sonar images are created. These images can view real-time moving targets, allowing the (continuously updating) moving target to be viewed provided it remains within the viewing volume.

Note, the sonar does not need to be physically moved to generate the 4D image as the individual 2D beams are directionally and range coherent. Additionally, the sonar's position and orientation are not required unless target absolute-position's (i.e. world coordinates) are required.

Since the processing results in data with a single value (target) per beam, this data can be considered a sparse volume; an overall volume of data is collected but only some targets in the volume are returned/visualized.

Conventional multibeam sonars use 1D arrays to produce 2D data in a manner similar to a simplified sonar imaging system. However, they can only produce a 3D image by moving the sonar while additionally knowing the location and orientation of the sonar to allow multiple pings to be merged to produce the 3D image. They cannot produce 4D images since they produce 3D data of a volume one line at a time for each ping, and the ping rate is limited by the time taken for sound to go from the sonar transmitter to the target and back to the sonar receiving array, and so cannot view moving targets (except possibly by seeing one instance of the target and thereby positioning it at a fixed, out-of-date, location).

When considering each beam's data, the returned echoes give an amplitude (i.e. echo strength) time-series, with typically a single value returned for the strongest target. Conventionally, for multibeam sonars being used for bathymetry, the strongest target is considered the seabed. Data in the time-series before the seabed is therefore “water column” data and on some sonars is presented as a method of looking for fish or other objects that can occur in the water-column.

Additionally, where beams are returned from the seabed at an oblique angle, the seabed echo can stretch over a large time-period, thus giving a sequence of amplitude values. Some multibeam sonars return this data as backscatter information, which when combined with the backscatter from surrounding beams allows a backscatter time series of the seabed to be viewed.

Both the water-column and backscatter data are 2D data, again requiring the location and orientation of the sonar to allow these to be combined to produce 3D data. Additionally, these data return/visualize partial time-series of the overall full time-series per beam.

In an embodiment, the sonar imaging system is enhanced to allow the echo strength (amplitude) time-series for each beam to be stored and processed in many more ways. Additionally, the processing improvements allow greater dynamic range (contrast) in the resulting amplitudes to be achieved. It is therefore now possible to view the full time-series of data for each beam, with greater contrast, and for this data to be acquired in real-time. With the time-series dimension now expanded from a single value to either a partial or full-time series, the data can be considered 5D data (two angles and range per point, multiple points and time).

The advantages of using full-time series data are most evident where a beam has a mixture of strong and weak reflectors. This would previously have only shown the strong reflector but now would show both. Additionally, since all values are available, variations in the amplitude allows greater contrast to be visualized between different objects.

Practical examples include gas leaks or sediment plumes when viewed across their volume, contain outer data that is typically lower in density and reflectance than their inner core data—the 5D system would reveal this image contrast as the volume data is penetrated to the brighter core. As another example, rock dumping and dredging show very different contrasts and moving objects within the scene—the rocks are brighter solid reflectors which will yield strong returns whilst the sediment and debris is more random and having weaker intensity. As yet another example, the marine growth around a piling or pipeline will have different image contrast to the solid surface and therefore show “image depth” in terms of this texture contrast information. As yet another example, fish schooling and habitat mapping contains many different bright and weak targets. Often the swim bladder shows as a bright reflector but the object is small enough for the sound waves to fully penetrate and continue to the next occluded target in the beam focal direction.

Full-time series however also includes the seabed backscatter data extracted from some multibeam data. This implies that where the seabed has sound hitting at an oblique angle, a range of amplitude values will be seen. This gives a fuller image of the seabed allowing greater detail and contrast to be viewed. This is particularly noticeable at the longer ranges of any seabed mapping application.

The use of a backscatter series of data need not be limited to seabed targets; it can also be used on other objects. For example, when tracking water-column objects in sonar data, any beams hitting the object obliquely can now return a larger number of points, so aiding the ability to track the object. This together with the improved contrast of the data is also likely to lead to improved confidence in determining the object's extent, shape, and shadow information if required.

The additional processing capability of the sonar imaging system allows more than one form of processing to be performed on each ping in real-time or in post-processing, potentially at the same time (parallel processing). For example, different windowing functions can be applied to help suppress noise at the expense of beamwidth (angular resolution), different sidelobe processing and/or thresholding can be applied to reduce unwanted acoustic artefacts at the potential expense of removing some good target data, etc. Since each of these different processing techniques can be run in parallel and each still produce a partial or full-time series 3D volume, this adds a further dimension to the processing, thus the data can be considered 6D.

Advantages to using 6D data include data not being lost by selecting inappropriate processing parameters. For example, previously selecting a high sidelobe clip level could clip out wanted objects. By using parallel processing, where high clip levels are deemed necessary due to noise, a lower clip can be run simultaneously. The lower clipped (noisier) data can be monitored to ensure no wanted objects are being removed, while the high-clip value gives noise free data.

Another advantage is that some applications may have limited communications available real-time, so a partial time series may be used real-time for visualization and decision-making while a full time-series is available for post-processing.

Yet another advantage is optimized sub-ping processing. Data within a ping can have parameters changed to optimize processing for that section of the sub-ping. For example, at short ranges the parameters can be different to those used at longer ranges.

The above techniques apply to the production of a one or more volumes of data from a single acoustic ping (except descriptions of ping sequences being used to view moving objects within the volume). However, many circumstances can require the merging of pings to create a larger viewing volume, often termed a mosaic. Here the ping volumes are relatively or absolutely located in both position and orientation to achieve the merge and avoid mosaic distortions.

Relative merging can use techniques such as Simultaneous Localisation and Mapping (SLAM) which merges data into a map (mosaic) while simultaneously determining the sonars position in the map. The merging process is achieved by matching identical features identified between two successive ping volumes and using these features to align the two pings. Successive pings are merged in turn, one-by-one. Typically, this technique works well if suitable ping features can be identified albeit, it can drift over long ping sequence mosaics. 5D or 6D data offers a larger data set to find suitable features to match and thus improves the chances of minimizing SLAM errors.

Alternatively, where position and orientation are directly measured for each ping, an absolutely positioned mosaic can be created. Here the mosaic can be augmented by introduction of models of known entities (vessels, platforms, ROVs, etc) to aid context. These models can also be moving and updated in real-time. 5D or 6D data improves this sort of mosaic by adding additional data and creating a fuller data set with less gaps. This type of mosaic may also be created using volume models (3D binned/gridded data) where each ping is added to the 3D binned data set. Again, the fuller data set will add more points to the volume and thus allow improved statistical processing to achieve better volume models, since this technique typically uses statistics on data on each bin hit; fuller data sets imply higher bin hits and therefore better statistics.

Mosaics can also be used to compare viewing volumes over time. Differences between a mosaic created using data from one time period are often compared to mosaics taken at a different time period. For example, to determine dredging progress, or to check for scouring around structures in areas with high underwater currents, or to check for changes in infrastructure (quay wall damage, explosive devices (IEDs) placed underwater, etc). Again, 5D or 6D data offer fuller, better data sets to allow improved comparisons.

The improvements to allow parallel processing means that processing parameters can be changed in real-time without affecting the processing functions. Where this is combined with different acoustic transmit and acquisition settings per ping, this allows different acoustic characteristics to be changed ping-to-ping. For example, different viewing volumes (opening angles and ranges), different resolutions, different pulse strengths, etc. The sonar imaging system records slice data as objects return signals responsive to sonar pings. The sonar imaging system may store the data (e.g., in a local store, such as on the head of the sonar imaging system, a remote store, such as a server or other, and so on). Doing so allows the data to be processed in various locations, or by various systems having certain resources.

By combing these changes into repeating ping sequences, the sonar can effectively do several tasks interleaved. For example, on an autonomous underwater vehicle (AUV), it can do one forward-looking, wide angled, low resolution ping for obstacle avoidance, followed by several downward-looking, high resolution pings for seabed mapping, and repeating this sequence. This is another form of parallel processing but at the task level rather than the signal or image processing level.

TABLE I
below provides a dimensions summary:

| # | Entity | Value | Description |
|---|---|---|---|
| 1 | Beam | Angle e.g. | 3D Position of a single target, can be |
| | | Horizontal | converted to X, Y, Z coordinates |
| 2 | Beam | Angle | |
| | | Perpendicular | |
| | | e.g. Vertical | |
| 3 | Beam | Range, | |
| | Object | Amplitude | |
| 4 | Ping | Time | Multiple pings to give a time sequence, |
| | | | required for looking at moving targets |
| | | | i.e. change in target's |
| | | | position/amplitude is seen |
| 5 | Beam | Time-series | A beam can have a single target, |
| | | of objects | multiple targets (partial time series) |
| | | | or display all beam data (full time |
| | | | series). Typically more data gives |
| | | | more information. |
| 6 | Ping | Processing | Pings can be processed multiple times |
| | | | using differing parameters to produce |
| | | | differing beam data and hence |
| | | | potentially different objects. |
| | | | Differences or similarities between |
| | | | these processing results could be useful. |

Examples for Time-Series of Objects
Partial time-series: divide overall beam range into multiple (typically equally-spaced) sections e.g. 10 sections; look for the strongest objects in each beam section. Results in 10 objects spread across the overall range.
Partial time-series: take every n-th value along the beam starting from the first value, then every nth value starting from the second value, etc. For example, for n=11, this gives 10 series of values where each series is interleaved and starting from 1, 2, . . . 10 respectively and spaced by 11 values. Look for the strongest object in each series. This results in 10 objects in the beam, but potentially grouped around a single large strong reflector.
Full-time series: takes every value and displays it.

Examples of Ping Processing
Different beamforming parameters: different 2D windowing functions e.g. Rectangular, Dolph-Chebychev, Tailor, etc trade off noise suppression versus beamwidth (i.e. angular resolution).
Different beamforming methods: time-domain, frequency-domain, etc trade-off speed/processing resources versus accuracy of the beamforming process. Less accuracy may result in distortions in the targets range and/or amplitude.
Different sidelobe suppression parameters: beamformed data has sidelobes (akin to leakage from adjacent beams). Processing functions designed to remove these artefacts can potentially remove desired targets.
Different algorithms can produce custom views on the data. For example, if cross-sections or plan views are required, processing can be run to output this data directly resulting in smaller data sets.

Example data from a view might show a series of images, in which one image shows a horizontal slice from the 5D full-time-series (FTS). In this example, each beam returns 900 objects (range/amplitude) and there are 128 beams (horizontal). Another image might show a close up of the first 300 of the 900 objects and the third image highlights the (very sparse) 128 objects that would be returned by the sonar imaging system.

Multi-Ping Steered Phased Array and Transmitter System

The resolution and achievable Field of View from a Subsea Acoustic Imaging sonar system utilizing either a 1D or 2D Phase Array and digital beamforming is constrained by three key factors: Array Size, Operating Frequency and Number/Size and Spacing of receiver elements in the array. As the size of the receiver array decreases, one typically must increase the frequency to maintain the same resolution or acoustic beam width.

1D Array systems can only generate a slice of either 2D Imagery data or range data as a profile. Whilst technically it would be feasible to steer slices of beams to create a volumetric 3D image, given speed of sound in water the time taken to construct an image and the resultant latency from the first to last slice over a typical useful range for 20 m would render this type of system unusable for real-time imaging. Although 1D array systems benefit from significantly reduced number of receiver elements, power and complexity, the sonar imaging system therefore uses a full 2D phased array system to generate a true 3D image.

For all but very short-range ultra-high resolution acoustic imaging requirements, existing 2D array systems can adequately generate real-time 3D volumetric imagery with sufficient resolution comparable to or even exceeding that of traditional multibeam sonar imaging technology.

Given the complexity and physical constraints of a 2D array operating at high frequency (>1 MHz) it would be exceptionally challenging, costly and impractical to develop a 2D array capable of simultaneously delivering the required resolution and field of view. Another beamforming approach should therefore be considered for high-frequency, real-time, 3D beamforming.

The combination of ultra-high resolution and short range applications present the opportunity to develop a 3D Volumetric HD Imaging from Compact Multi-Ping Steered Phased Array and Transmitter System. As mentioned previously, if the sonar imaging system uses a 1D array system (such as a multibeam or profiler) with say 128 beams generated per slice, it would be necessary to beam steer 128 different slices sequentially in order to construct a full 128×128 image. Assuming a range of 7.5 m and allowing for ringing time on the transmitter, each slice would take approximately 15 ms (10 ms detection with 5 ms dampening) per slice with two-way echo detection, and therefore 1,920 ms or 1.9 seconds to generate a single 3D frame. For real-time imaging underwater it is accepted that 5-10 hz is the minimum frame or pulse interval required. Therefore, electronic beam steering of a 1D array does not meet any form of real-time requirements, even before addressing the latency and motion compensation required of the sonar mounted platform.

Using the 2D array and beamformer populated for mid-range, medium-frequency imaging and increasing greatly the operating frequency brings the grating lobes of the receiver much closer, impacting achievable Field of View. For example, using a system design for 50×50 degree field of view at 400 kHz and increasing the frequency to 800 kHz would limit the field of view to 25×25 degrees to avoid these grating lobes. It is possible however that the entire smaller volume (25×25 degrees) can be steered off center axis and still retain the same field of view. Using this technique, it is feasible in this example to use only 4 sequential ping transmissions to complete the entire original 50×50 image, but at a much higher frequency, and therefore higher resolution. Increasing the frequency further only decreases the field of view to avoid grating lobes and therefore would require more ping collections to reconstruct the entire image.

The 3D real-time functionality of the sonar imaging system can easily beamform fully formed volumetric pings at short range in excess of 20 Hz such that a sequence of multiple pings can be achieved with a combined refresh rate of 5 Hz. An example of 4 such steered volume pings would still allow a full refresh frame rate of 5 Hz.

The present disclosure is further expanded with additional intelligent and predictive processing and inter-frame alignment for motion and moving objects. In given applications, the priority of frame processing can be adapted to allow focus and higher refresh of the primary target (center of FoV) or moving objects requiring that portion of the field of view to be updated.

Intelligent steering of the high-resolution, focused field of view on to a specific target of interest would mean that this technology would not necessarily be limited only to short range applications. If only one of the four steered pings (for example) needs to be continuously updated to generate real-time images, then the range limit could be significantly extended. The intelligent focusing could be implemented using an updated version of ping-pong mode, whereby the low-frequency, low-resolution ping with a large FoV is used to locate the target of interest. The subsequent high-frequency, high-resolution ping could then be directed to look specifically at the region of interest without having to physically steer the sonar head.

Current approaches to 3D real-time sonars technology with fully populated 2D arrays either compromise on Field of View, Frequency and Resolution. It is highly complex to design a portable system with low power and sufficient resolution for short-range applications. Currently sonar imaging systems may be limited to 700 kHz with a beamwidth of 0.6 deg and a field of view of 24×24. In short range applications such as 5 m from target. This equates to only a 2.5 m×2.5 m field of view and a beam footprint of 5 cm. Compare this to either a 50×50 deg field of view or 5 m×5 m with same resolution, or a retained 14×24 degree image with 1.4 MHz imaging giving a beam footprint at 5 m of 2 cm.

The sonar imaging system having 3D real-time sonar will therefore be capable of now much greater field of view imaging (useful for breakwater construction and diver applications or much higher resolution imaging on the same sized system with a practical FoV). Further, based on the complexity of the steering pattern and the target, requires increased transmitter switching capability ping to ping. In some respects the improved sonar of the invention answers many of the limitations of the FoV of the sonar imaging system, but more importantly it will address the needs of very high resolution sonar imaging currently exclusive to 2D imaging and laser technology.

Globally the phrase 3D has a well-defined understanding which is (X,Y,Z) in some Cartesian coordinate system. For sonar data it implies that the sonar imaging system has some intensity value of a signal (I) at some position in space. For example:
3dData Point=x,y,z, intensity
   Traditional sonar data beamforms to an Intensity at some (U,V,Range) PolarCoodinates where U and V are angles.

There is a transform that can convert Polar(U,V,Range) to Cartesian(X,Y,Z).

For sonar data the sonar imaging system chose to limit the number of Range values such that:
Echoscope3dData=(u,v,range), intensity=>Transform2D=>3D Data=x,y,z, intensity, where Transform2D is limited to 1 range value per (u,v). So 4D data inherits this limitation from Echoscope3dData
4D=2D(uv)+(singleRange))+time (say 2.5D)+time=3.5D
EsFts3dData=(u,v,range), intensity=>Transform3D=>3D Data=x,y,z, intensity, where Transform3D allows multiple range values per (u,v)
5D=3D(uv) (multipleRange)+time (multipleRange)=(Really 3D)+time=4D

When beamforming the sonar imaging system attempts to correct for range based errors. Initially this was just TimeVaryingGain (TVG) where the sonar imaging system increases RxGain based on range to correct for attenuation in the water column. This gain is applied based on range (distance from transmitter).

In FTS, the sonar imaging system can take this further by applying additional gain pre beamforming (e.g., through phase filtering techniques described herein), and applying additional gain post beamforming (e.g., through thresholding techniques described herein). These gains can be calculated by looking at intensity values in each slice and applying a filter, as the intensity value of consecutive slices should not vary by a lot.

There are some beamforming values that it may be advantageous to change over time. These are (i) Thresholding—Currently the sonar imaging system applies a single threshold value based for all slices in a ping, This assumes that the average intensities of all slices are the same, regardless of range. This may not be the case. FTS can allow the user to specify a variable threshold over range. This could be: single value as the sonar imaging system has just now; a ramp value (gets bigger or smaller over range); a series of thresholds at different ranges, that are interpolated between; and/or, a threshold table with a value per slice; (ii) Phase Filtering—Currently the sonar imaging system applies the same shaping filter to all slices before beam forming; FTS can allow the user to vary the filters over range. This could be: single value as the sonar imaging system has just now; a ramp value (gets bigger or smaller over range), a series of filters at different ranges, that are interpolated between; and a filter table with a filter per slice; (iii) Depth Filtering—If the sonar imaging system has the maximum depth of the location being surveyed (approximate sea bottom plane), the sonar imaging system can use this information to discard points (and possibly slices) that the sonar imaging system knows. In particular this is useful to remove reflected data (multi path); and (iv) Range Calculation—The meaning of range can be: range from head or range from some feature (point) track (line) or surface (plane) in world space (i.e., the sonar imaging system implementing FTS). The FTS system has a tilt sensor, so it can use its own orientation to calculate where the sea bottom may be (maximum possible range). It also can subscribe to the Navigation provider, so it knows its position in world space.

As an example use case, if the sonar imaging system is surveying a harbor wall, the sonar imaging system may beamform the data before the wall (sea bottom—oblique to beams (low backscatter) soft (low intensity) differently from the harbor wall (orthogonal to beams (high back scatter) hard, high intensity. If a user of the sonar imaging system specifies a chart line where the wall is, the head component of the sonar imaging system can use a Nav function to work out what ranges are before the wall and what are after.

As another example, if the sonar imaging system has the sea depth, two planes can be specified (e.g., SeaSurfacePlane and SeatBottomPlane). In such a case, data between these planes will be processed and sent from the head to the top end. (Like clip planes in USE but done on head)

Embodiments presented herein disclose a sonar imaging system providing 5D and 6D imaging techniques. 3D imaging (e.g., shape, 3D XYZ data) typically is the scanning of an object of a sequence of images to construct a 3D shape. The limitation of this approach is the inability to see any moving objects and having a high dependency of a stable platform to perform the imaging. 4D volumetric images (e.g., time, moving objects) represent a true volume of spatial data collected and processed at the same instant. Sequential 4D volumetric images represent a time sequence of the scene showing moving objects within the volumetric image. 5D images (e.g., depth, time series) are 4D images with multiple slices of depth data, similar to a medical CT Scan. The 5D images contain more depth information, detail and resolution of each target and sequential 5D images over time show higher resolution moving targets. 6D parallel intelligent processing engine (PIPE) allows multiple parallel 5D images to be generated with different imaging and sonar parameters. This allows different processing to be performed on raw sonar data in parallel and extract more specific results without compromise.

In an embodiment, the sonar imaging system provides a specialized processor that allows the sonar data to be handled orders of magnitude faster, and with much greater flexibility, or stored for off-line processing. The biggest change facilitated by this processor is the ability to beamform the entire duration of each sonar ping to give full time series (FTS) data on all beams. Rather than just returning at most a single 1 dimensional range point for each beam to create an image with a maximum 16,384 points), the new system returns a fully populated volume of over 1.6 million beamformed data points, while still operating at over 20 pings per second.

The ability to return multiple data points on every beam takes the data to the next generation and presents a wealth of new opportunities for analyzing the sonar data. The biggest initial advantage is that the 5G system generates much fuller, and more detailed images when the points are rendered in 3D, as the beamformer can potentially see around smaller objects in the near-field. The system also returns multiple range points for beams striking flat surfaces at high incidence angles, meaning that the seafloor is much better resolved in the far field of the volume image.

The specialized processor has also allowed the sensitivity of the beamformer to be increased, as its floating-point operation allows for a much greater dynamic range in the data. This is a significant advantage in many acoustically challenging applications and environments. The combination of having multiple range points recorded for each beam and the increase in sensitivity means that the far-field can be much more clearly and densely resolved in the output images.

The major increase in the quality and volume of data generated by the 5G system means that new types of data processing are possible, and new, useful information can be extracted. The challenge with large datasets, however, is that they can be slow and cumbersome to analyses. To address this issue, the sonar imaging system implements a parallel information processing engine (PIPE). This tool adopts novel parallel processing methods to perform multiple, simultaneous analyses of the large 5G dataset, delivering a range of useful outputs in real time. This ability to produce multiple, concurrent 5GD datasets takes the new system to its sixth data dimension (6G).

PIPE allows for hardware updates to be implemented to maximize the functionality of this new tool. Different 5G data outputs might require different signals to be transmitted from the sonar, or might need different signal amplification and filtering operations to be applied. For example, one task might need high-resolution and a narrow field of view, while another could require a low-frequency, long range signal with a wide field of view. PIPE allows these different 5G datasets to be processed concurrently by switching between many different sets of sonar operating parameters, with this switching occurring from ping to ping at 20 Hz. It is possible, for example, to generate four completely different 5G sonar images separated by less than 0.05 sec, with the composite, 6G image being fully updated 5 times per second.

To understand the full potential of this new technology, consider a pipe inspection operation being conducted with an ROV. The ROV pilot requires a longer range, forward looking view to allow both navigation and obstacle avoidance. There could then be an engineer inspecting the condition of the pipe itself, who requires a high resolution, downward looking image to be able to detect damage or corrosion on the pipe. The 6G PIPE system is capable of generating both these images simultaneously in real time, meaning that the engineers are able to make instant decisions, such as whether to slow down to inspect a particular section of pipe in more detail.

Since the raw data from the survey is also being stored, it is possible to go back through the data in post-processing and apply different image processing methods to highlight different information. This does not provide quite the same flexibility as the real-time 6G processing, as the transmit and receive parameters are fixed. There is still significant value, however, in having access to the measured raw data rather than a processed image that has already removed a large proportion of the original information.

The 5G/6G functionality in the sonar imaging system is the sonar for the information age. It uses the very latest hardware and software to open up a range of new possibilities for visualizing and analyzing the underwater environment. The 5G/6G system is also ideally placed to satisfy the future needs of the growing fleet of autonomous vessels in the world's oceans, lakes and rivers. It therefore looks likely that the new generation of Coda Octopus 5G/6G Echoscopes will continue to lead the field, as their 4D predecessors have done before them.

Obviously, many modifications and variations of the present invention are possible in light of the above teachings. It is therefore to be understood that, within the scope of the appended claims, the invention may be practiced otherwise than as specifically described.

### EXAMPLES

Illustrative examples of the technologies disclosed herein are provided below. An embodiment of the technologies may include any one or more, and any combination of, the examples described below.

Example 1 includes a method of recording a 3D sonar image, comprising transmitting a series of sonar pings into a first volume of water, the series of sonar pings transmitted from a sonar ping transmitting device at a rate at least 5 pings per second, wherein the sonar ping transmitting device is controlled by sonar ping transmitting parameters, and wherein each sonar ping transmitting parameter is chosen from predetermined list of sonar transmitting parameter settings; receiving sonar signals reflected or scattered from objects in the first volume of water from each of the series of sonar pings, the received sonar signals received by a large two dimensional array sonar receiving device; wherein the sonar receiving device is controlled by sonar receiving parameters, and; beamforming the received sonar signals from each of the series of sonar pings with a sonar beamforming device to form a three dimensional (3D) sonar image of the objects reflecting or scattering the received sonar signals, wherein the sonar beamforming device is controlled by a set of sonar beamforming parameters, wherein each sonar beamforming device parameter is chosen from predetermined list of sonar beamforming device parameter settings, wherein at least one of the sonar transmitting parameters; sonar receiving parameters, or sonar beamforming parameters is changed in the time between any two sonar pings of the series of sonar pings, wherein the transmitter frequency is changed in the time between any two sonar pings of the series of sonar pings, wherein the transmitter frequency is changed from a first frequency to a second frequency and back between each ping of the series of sonar pings, wherein a sonar beamforming device parameter wherein each is changed between each ping of the series of sonar pings, wherein the transmitter frequency and the insonified volume are changed in the time between any two sonar pings of the series of sonar pings, wherein at least one sonar beamforming parameters is changed in the time between any two sonar pings of the series of sonar pings, wherein at least two different fields of view are imaged in the series of sonar pings, wherein at least four different fields of view are imaged in sequence in the series of sonar pings, wherein images of the four different fields of view are stitched to make one composite image, and/or wherein the a series of composite images is presented as a video presentation with a frame rate of at least 5 frames per second.

Example 2 includes a method of real time three dimensional (3D) sonar imaging, comprising insonifying a first volume of fluid with a first series of at least one sonar ping transmitted by a first sonar transmitter; wherein the first sonar transmitter frequency has a first sonar transmitter frequency parameter set to a first sonar frequency; changing the first sonar transmitter frequency parameter to a second sonar frequency; transmitting a second series of at least one sonar ping; recording a video presentation of the series of 3D sonar images shown sequentially at a rate greater than 5 images per second; producing a series of sonar images by alternating the first sonar transmitter frequency parameter between the first and the second sonar frequencies ping to ping; stitching neighboring pairs sonar images of the series of 3D images to make a third series of composite sonar images having a wider field of view than images in the first series and a resolution over portions of the field of view higher than images in the second series; recording a video presentation of the composite 3D sonar images shown sequentially at a rate greater than 5 images per second; wherein the time between the last sonar ping of the first series of sonar pings and the first sonar ping of the second series is less than 0.2 seconds, and wherein the first series of sonar pings and the second series of sonar pings are transmitted at a rate greater than 5 pings a second; receiving for each of the series of sonar pings sonar signals reflected from one or more objects in the volume of fluid, wherein the sonar signals are received with a large 2D array of sonar signal detectors; and beamforming the reflected sonar signals for each of the series of sonar pings to provide a series of three dimensional (3D) sonar images of the one or more objects, wherein resulting images alternate between a higher resolution and smaller field of view for the higher frequency and a lower resolution and larger field of view for the lower frequency, and the alternating images are stitched after the receiver stage to provide video stream with a higher central resolution and wider field of view at half the frame rate of the system available with unchanged parameters, wherein resulting images alternate between a higher resolution and smaller field of view for the higher frequency and a lower resolution and larger field of view for the lower frequency, and the alternating images are stitched as neighboring images to provide a video stream at the same frame rate but a larger field of view, wherein only a subset of the at least four images is updated continuously to generate real time images, wherein intelligent processing is used to account for and/or track motion of moving objects, and/or wherein predictive processing is used to account for and/or track motion of moving objects.

Example 3 includes a method of recording a 3D sonar image, comprising transmitting a series of sonar pings into a first volume of water, the series of sonar pings transmitted from a sonar ping transmitting device at a rate at least 5 pings per second, wherein the sonar ping transmitting device is controlled by sonar ping transmitting parameters, and wherein each sonar ping transmitting parameter is chosen from predetermined list of sonar transmitting parameter settings; receiving sonar signals reflected or scattered from objects in the first volume of water from each of the series of sonar pings, the received sonar signals received by a large two dimensional array sonar receiving device; wherein the sonar receiving device is controlled by sonar receiving parameters; beamforming the received sonar signals from each of the series of sonar pings with a sonar beamforming device to form a three dimensional (3D) sonar image of the objects reflecting or scattering the received sonar signals, wherein the sonar beamforming device is controlled by a set of sonar beamforming parameters, and wherein each sonar beamforming device parameter is chosen from predetermined list of sonar beamforming device parameter settings; changing at least one beamforming parameter in the time between any two sonar pings of the series of sonar pings to produce at least two real time beamformed data sets for the same ping; and combining the at least two real time beamformed data sets to produce a single video frame image in the time between two sonar pings, wherein the combined beamformed data sets have more than one value for at least one beam, wherein the two real time data sets are the FAT data set and the MAX data set, wherein the two real time data sets have different range settings; wherein the two real time data sets have different time varying gain (TVG) settings; and/or wherein the two real time data sets have different Field-of-View (FOV) settings.

Example 4 includes a method of real time three dimensional (3D) sonar imaging, comprising insonifying a volume of fluid with a series of sonar pings, the sonar pings, wherein the series of sonar pings are produced at a rate greater than 5 pings a second; receiving for each of the series of sonar pings sonar signals reflected from one or more objects in the volume of fluid, wherein the sonar signals are received with a large 2D array of sonar signal detectors; beamforming the reflected sonar signals to provide a series of (3D) sonar images of the one or more objects; wherein the beamforming procedure is changed from ping to ping to produce a series of images having different field of view (FOV) for each of at least two consecutive pings; stitching at least two consecutive images of the series of 3D images to make a composite 3D image having a wider field of view than any one of the series of (3D) sonar images; recording a video of the composite images, wherein the video shows composite single images stitched from four consecutive images, the composite images shown sequentially at a rate greater than 5 images per second; identifying an object of interest from at least one image of the series of 3D images of the one or more objects; and changing the field of view of at least one succeeding ping is to provide further images of the object of interest, wherein four consecutive images of the series of 3D images having different fields of view are stitched together to produce a single image, wherein the field of view is changed so that the beamformed image of the object of interest is approximately in the center of the changed field of view in succeeding pings, wherein changing the beamforming procedure from ping to ping includes inserting a programmable set of delays in sonar signals received by each element of the large array of sonar signal detectors, wherein a subset of the at least two consecutive images of the series of 3D images is updated continuously to generate real time images, wherein intelligent processing is used to account for and/or track motion of moving objects, wherein predictive processing is used to account for and/or track motion of moving objects, wherein interframe alignment is used to account for and/or track motion of moving objects, and/or wherein the portion of the field of view containing the motion of the moving objects is updated more frequently than the remaining portions of the field of view.

Example 5 includes a method of recording sonar data measured by a sonar system having sonar system parameters, comprising transmitting a first set of sonar pings into a first volume of sonar signal transmitting material, the sonar pings transmitted from a sonar ping transmitting device, wherein the sonar ping transmitting device is controlled by a first set of ping transmitting parameters chosen from a predetermined list of ping transmitting parameters; receiving sonar acoustical signals reflected or scattered from objects in the first volume of sonar signal transmitting material, wherein the received acoustical sonar signals are received by a sonar receiving device array controlled by a first set of receiver parameters selected from a predetermined list of receiver parameters to convert the received sonar acoustical signals into digital data signals which are transmitted to a sonar beamforming device and/or a digital processing device for further processing of the digital data signals; beamforming and/or further processing the received sonar signals wherein sonar beamforming is performed by a sonar beamforming device controlled by a first set of beamforming parameters chosen from a predetermined list of beamforming parameters, and wherein the digital processing device for further processing is controlled by parameters chosen from a predetermined list of processing device parameters; and changing at least one sonar system parameter to provide at least two significantly different three dimensional (3D) sonar data sets for each ping of the first set of pings, the at least two (3D) sonar data sets for describing the objects reflecting or scattering the transmitted sonar signals, wherein a sonar system parameter is defined as any parameter chosen from the predetermined lists of ping transmitting parameters, receiver parameters, beamforming parameters, and processing device parameters; changing at least one of the sonar beamforming device parameters for each ping of the first set of pings during beamforming; and changing at least one of the sonar receiving device parameters during receiving for each ping of the first set of pings, wherein the at least two significantly different sonar data sets are used to provide at least two significantly different beamformed sonar images, wherein two different gain profiles are used to provide two significantly different data sets for each ping of the first set of pings, wherein the sonar system parameters are set to provide sonar data to reconstruct a consolidated image from the requested eyepoints of a more than one user, wherein the image resolution is changed during the sonar signal receiving from higher resolution for the first arriving ping reflection to lower resolution for the later arriving ping reflections, wherein features identified in two or more data sets for each ping are matched with corresponding features identified in at least one further data set to provide a mosaic data base, wherein the at least one further data set for a ping is produced from preceding and/or succeeding pings, and wherein in the sonar device parameter changed is a digital processing device parameter, wherein the digital processing device parameter changed is a sidelobe clipping parameter and/or a thresholding parameter, wherein the at least one digital processing device parameter changed is chosen to reduce unwanted acoustic artefacts, wherein one of the at least two significantly different sonar data sets for each ping of the first set of pings is a full-time series 3D volume data set or a partial series 3D volume data set, wherein two of the at least two significantly different sonar data sets are a full-time series 3D volume data set and a partial series 3D volume data set, wherein the at least one digital processing device parameter is changed from a first sidelobe filter to a second sidelobe filter, wherein the sonar data set produced using the first sidelobe filter is monitored in real-time to ensure no wanted objects are being removed, wherein the image resolution is changed during the sonar signal receiving from higher resolution for the first arriving ping reflection to lower resolution for the later arriving ping reflections, wherein features identified in the two or more data sets are matched with a Simultaneous Localization and Mapping (SLAM) technique, wherein an absolutely positioned mosaic is created, wherein the two or more data sets for each ping are matched with models, wherein the models represent known physical entities, wherein the models may be moving and/or updated in real-time, wherein the models are volume 3D binned data, wherein the two or more data sets for each ping are compared with at least one previously generated data set, wherein the previously generated data set may be from a previous survey of the same physical location, wherein the comparison is used to determine dredging progress and/or to check for scouring around structures in areas with high underwater currents and/or to check for changes in infrastructure, wherein the two or more data sets for each ping are matched with data from previously surveyed areas to find to determine dredging progress and/or to check for scouring around structures in areas with high underwater currents and/or to check for changes in infrastructure such as quay wall damage and/or explosive devices placed underwater, wherein the range of at least one of the at least two significantly different data sets is divided into a number of sections, and the range of zero or one object for each section is recorded and/or shown as a partial time-series, wherein at least one of at least two significantly different beamformed sonar images is a custom view, wherein the custom view is a cross section or a plan view, wherein the first set of sonar pings forms part of a series of sets of sonar pings transmitted at a rate of at least 5 pings per second, wherein the least two significantly different sonar data sets representative of the first set of sonar pings are displayed as at least one video stream at a frame rate of at least 5 frames per second, wherein two sets of sonar data are recorded and/or shown, wherein at least two significantly different sonar data sets for each ping of the first set of pings are used to simultaneously provide a far-field obstacle avoidance view and a high-resolution seabed view, wherein the far-field obstacle avoidance view and the high-resolution seabed view are used in autonomous navigation, and/or wherein at least one of the at least two significantly different sonar data sets for each ping comprises raw data.

### FURTHER EXAMPLES

Additional illustrative examples of the technologies disclosed herein are provided below. An embodiment of the technologies may include any one or more, and any combination of, the examples described below.

Example 1 includes a method for recording sonar data measured, the method comprising transmitting, by a sonar system having a beamformer, the beamformer configured with one or more parameters, a plurality of sonar ping into a volume of sonar signal transmitting material; receiving, by the sonar system, a plurality of signals from one or more objects in the volume of sonar signal transmitting material responsive to a first sonar ping of the plurality of sonar pings; beamforming, by the sonar system, the plurality of signals under the one or more parameters to generate a first three-dimensional (3D) beamformed sonar data set for the first sonar ping, the first sonar data set describing the one or more objects; changing, by the sonar system, at least one of the one or more parameters; and beamforming, by the sonar system and prior to receiving a plurality of second signals responsive to a second sonar ping of the plurality of sonar pings, the plurality of signals under the changed at least one of the one or more parameters to generate a second 3D beamformed sonar data set for the first sonar ping, the second 3D sonar data set describing the one or more objects, the second 3D beamformed sonar data set being different from the first 3D beamformed data set.

Example 2 includes the subject matter of Example 1, and further including, identifying a plurality of sub-sections of the first sonar ping, wherein changing the at least one of the one or more parameters comprises changing the at least one of the one or more parameters specific to one of the plurality of sub-sections of the first sonar ping.

Example 3 includes the subject matter of any of Examples 1 and 2, and wherein the received plurality of signals are digital data signals converted from acoustic signals for further processing.

Example 4 includes the subject matter of any of Examples 1-3, and further including, storing the digital data signals in a local store.

Example 5 includes the subject matter of any of Examples 1-4, and further including, storing the digital data signals in a remote store.

Example 6 includes the subject matter of any of Examples 1-5, and further including, determining, whether to perform one or multiple types of beamforming analyses to the plurality of signals.

Example 7 includes the subject matter of any of Examples 1-6, and wherein changing the at least one or more parameters comprises, upon determining to perform multiple types of beamforming analyses, applying a First Above Threshold (FAT) analysis and a maximum amplitude (MAX) analysis on the plurality of signals.

Example 8 includes the subject matter of any of Examples 1-7, and further including, outputting an image representing a combination of the FAT analysis and an image representing the MAX analysis.

Example 9 includes the subject matter of any of Examples 1-8, and wherein the further processing comprises changing another at least one of the one or more parameters for the first sonar ping; and beamforming, by the sonar system, the plurality of signals under the changed another at least one of the one or more parameters to generate a third 3D beamformed data set for the first sonar ping, the third 3D beamformed data set describing the one or more objects.

Example 10 includes the subject matter of any of Examples 1-9, and wherein the one or more parameters includes at least one of a 2D windowing function, a beamforming method, a sidelobe suppression parameter, thresholding parameter, and view parameter.

Example 11 includes the subject matter of any of Examples 1-10, and wherein the one or more parameters are set to provide sonar data to reconstruct a consolidated image from requested eyepoints of a user.

Example 12 includes the subject matter of any of Examples 1-11, and wherein changing the at least one of the one or more parameters comprises changing from a cross-section view to a plan view.

Example 13 includes the subject matter of any of Examples 1-12, and wherein changing the at least one of the one or more parameters comprises changing the beamforming method from a time-domain to a frequency-domain method.

Example 14 includes the subject matter of any of Examples 1-13, and further including, identifying one or more features in the first and second 3D beamformed sonar data sets.

Example 15 includes the subject matter of any of Examples 1-14, and further including, outputting an image from the first 3D beamformed sonar data and an image from the second 3D beamformed sonar data set.

Example 16 includes the subject matter of any of Examples 1-15, and further including, combining, prior to receiving the plurality of second signals, the first and second 3D beamformed sonar data sets to generate a single video frame image.

Example 17 includes the subject matter of any of Examples 1-16, and further including, outputting the single video frame image.

Example 18 includes the subject matter of any of Examples 1-17, and wherein the sonar data set produced using a sidelobe filter is monitored in real-time to ensure no specified objects are being removed.

Example 19 includes the subject matter of any of Examples 1-18, and wherein a range of at least one of the first and second 3D beamformed sonar data sets is divided into a number of sections, and a range of one of the objects for each section is recorded or shown as a partial time-series.

Example 20 includes the subject matter of any of Examples 1-19, and wherein changing the at least one of the one or more parameters comprises changing the sidelobe clip level.

1. A method for recording sonar data measured, the method comprising:
transmitting, by a sonar system having a beamformer, the beamformer configured with one or more parameters, a plurality of sonar ping into a volume of sonar signal transmitting material;
receiving, by the sonar system, a plurality of signals from one or more objects in the volume of sonar signal transmitting material responsive to a first sonar ping of the plurality of sonar pings;
beamforming, by the sonar system, the plurality of signals under the one or more parameters to generate a first three-dimensional (3D) beamformed sonar data set for the first sonar ping, the first sonar data set describing the one or more objects;
changing, by the sonar system, at least one of the one or more parameters; and
beamforming, by the sonar system and prior to receiving a plurality of second signals responsive to a second sonar ping of the plurality of sonar pings, the plurality of signals under the changed at least one of the one or more parameters to generate a second 3D beamformed sonar data set for the first sonar ping, the second 3D sonar data set describing the one or more objects, the second 3D beamformed sonar data set being different from the first 3D beamformed data set.

2. The method of claim 1, further comprising, identifying a plurality of sub-sections of the first sonar ping, wherein changing the at least one of the one or more parameters comprises changing the at least one of the one or more parameters specific to one of the plurality of sub-sections of the first sonar ping.

3. The method of claim 1, wherein the received plurality of signals are digital data signals converted from acoustic signals for further processing.

4. The method of claim 3, further comprising, storing the digital data signals in a local store.

5. The method of claim 3, further comprising, storing the digital data signals in a remote store.

6. The method of claim 1, further comprising, determining, whether to perform one or multiple types of beamforming analyses to the plurality of signals.

7. The method of claim 6, wherein changing the at least one or more parameters comprises, upon determining to perform multiple types of beamforming analyses, applying a First Above Threshold (FAT) analysis and a maximum amplitude (MAX) analysis on the plurality of signals.

8. The method of claim 7, further comprising, outputting an image representing a combination of the FAT analysis and an image representing the MAX analysis.

9. The method of claim 3, wherein the further processing comprises:
changing another at least one of the one or more parameters for the first sonar ping; and
beamforming, by the sonar system, the plurality of signals under the changed another at least one of the one or more parameters to generate a third 3D beamformed data set for the first sonar ping, the third 3D beamformed data set describing the one or more objects.

10. The method of claim 1, wherein the one or more parameters includes at least one of a 2D windowing function, a beamforming method, a sidelobe suppression parameter, thresholding parameter, and view parameter.

11. The method of claim 10, wherein the one or more parameters are set to provide sonar data to reconstruct a consolidated image from requested eyepoints of a user.

12. The method of claim 10, wherein changing the at least one of the one or more parameters comprises changing from a cross-section view to a plan view.

13. The method of claim 10, wherein changing the at least one of the one or more parameters comprises changing the beamforming method from a time-domain to a frequency-domain method.

14. The method of claim 1, further comprising, identifying one or more features in the first and second 3D beamformed sonar data sets.

15. The method of claim 1, further comprising, outputting an image from the first 3D beamformed sonar data and an image from the second 3D beamformed sonar data set.

16. The method of claim 1, further comprising, combining, prior to receiving the plurality of second signals, the first and second 3D beamformed sonar data sets to generate a single video frame image.

17. The method of claim 16, further comprising, outputting the single video frame image.

18. The method of claim 1, wherein the sonar data set produced using a sidelobe filter is monitored in real-time to ensure no specified objects are being removed.

19. The method of claim 1, wherein a range of at least one of the first and second 3D beamformed sonar data sets is divided into a number of sections, and a range of one of the objects for each section is recorded or shown as a partial time-series.

20. The method of claim 19, wherein changing the at least one of the one or more parameters comprises changing the sidelobe clip level.
